(19) United States
(12) Patent Application Publication
(10) Pub. No.: US 2010/0078457 A1
(43) Pub. Date: Apr. 1, 2010

(54) HOODED BACKPACK AND SPEAKER COMBINATION DEVICE AND METHOD THEREFOR

(76) Inventors: SCOTT PITCHFORD, Las Vegas, NV (US); Charles Whitney, Las Vegas, NV (US)

Correspondence Address: WEISS & MOY PC, 4204 NORTH BROWN AVENUE, SCOTTSDALE, AZ, 85251, US

(21) Appl. No.: 12/240,821

(22) Filed: Sep. 29, 2008

(51) Int. Cl. A45C 15/00; A45F 3/04; A41D 3/00; A41D 27/20; H04R 1/02

(52) U.S. Cl. 224/576; 224/587; 224/259; 224/652; 2/84; 2/249; 381/388

(57) ABSTRACT

A hooded backpack and speaker combination device which has a plurality of pockets on its shoulder straps for housing various electronic devices including a switch pocket and switch allowing communication with a selected electric device via speakers housed within a hood attached to the top of the backpack.

### FIELD OF THE INVENTION

The present invention relates to backpacks, and more specifically, to a hooded backpack with speakers located within the hood for use in combination with a plurality of electronic devices.

### BACKGROUND OF THE INVENTION

With the portability of music and other media on the rise due to technological innovation in the field of electronic media devices, the demand for various devices to be used in connection with the portability of these media has also risen. A recent study indicates that as many as one in five Americans over the age of 12 now own a portable media playing device such as an MP3 Player and one in 20 own more than one portable media playing device. Interest in viewing music videos, photos, TV shows and even full-length movies from these devices is especially strong among younger consumers who have experience downloading music these media.

Most portable media playing devices require the use of headphones to hear the audio component of the media being played. The concurrent use of headphones with the hood up, for example, a hooded jacket has proven to be awkward and cumbersome due to the fact that both devices will be concurrently placed over the head and ears of a user and may interfere with the comfort or placement of one another.

Therefore, a need exists to provide a device and method to overcome the above problem. The device and method needs to provide a hooded backpack having speakers located within the hood portion of the backpack capable of use with a plurality of electronic devices.

### SUMMARY OF THE INVENTION

In accordance with one embodiment of the present invention, a device for carrying objects is disclosed. The device uses a backpack. A pair of shoulder straps is coupled to the backpack. A hood is coupled to a top section of the backpack and positioned so that a wearer of the backpack is capable of placing the hood over a head of the wearer. At least one speaker is coupled to the hood.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

Embodiments of the disclosure will become more fully understood from the detailed description and the accompanying drawings, wherein:

FIG. 1 is a front perspective view of one embodiment of the present invention;

FIG. 2 is another front perspective view of the embodiment depicted in FIG. 1 showing additional details;

FIG. 3 is a front perspective view of the embodiment depicted in FIG. 1 with the hood stored;

FIG. 4 is an exploded view of the embodiment depicted in FIG. 1;

FIG. 5 is a front perspective view of the speakers and microphone located in the hood of the embodiment depicted in FIG. 1; and

FIG. 6 is a simplified functional block diagram showing the electronic switch used in the present invention.

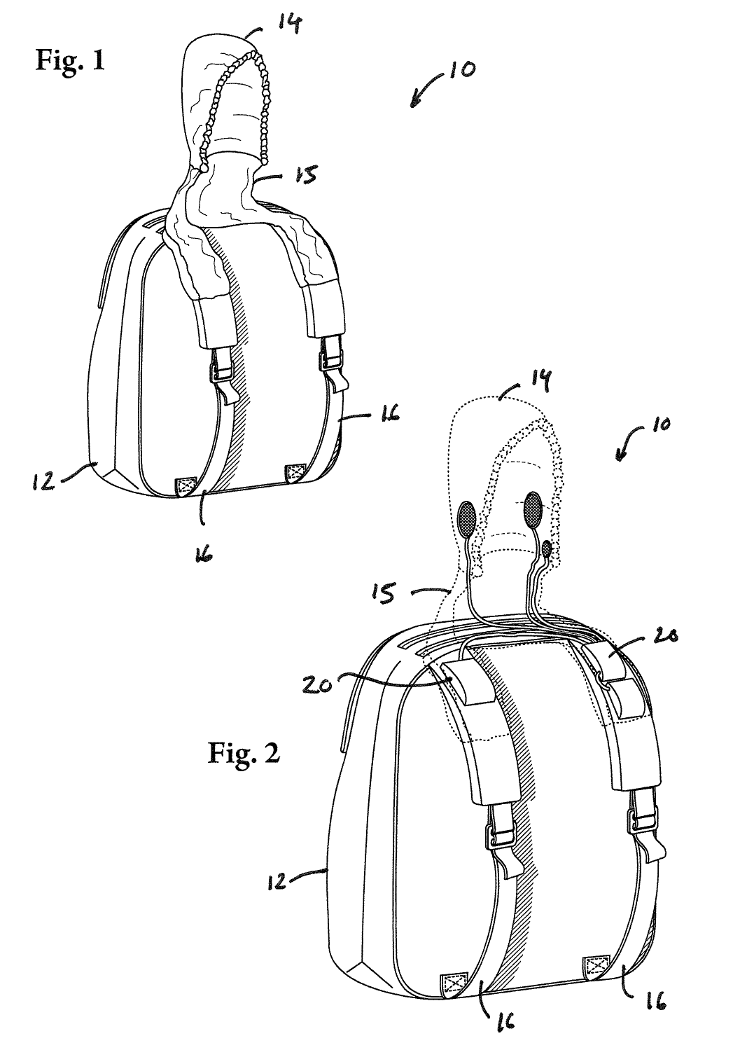

### DETAILED DESCRIPTION OF THE INVENTION

Referring to the Figures, a hooded backpack and speaker combination device 10 (hereinafter device 10) is shown. The device 10 will be capable of discretely holding an electronic circuit 30 which allows a wearer of the device 10 to switch between a plurality of different electronic devices 32 stored in the device 10.

The device 10 has a backpack 12. The backpack 12 may be any type of backpack 12 having one or more storage compartments. The backpack 12 may be made out of nylon, micro-fiber, canvas, or the like. In general a waterproof material may be used. However, other types of material may be used without departing from the spirit and scope of the present invention.

The backpack 12 will generally have a pair of shoulder straps 16. Each shoulder strap 16 is attached to a top and bottom section of the backpack 12. The shoulder straps 12 allow a user to wear the backpack 12 by placing each of the shoulder straps 16 over a shoulder of a wearer.

Each shoulder strap 16 may have one or more pockets 20. The pockets 20 are used to store and hold the electronic devices 32. The pockets 20 will further hold a switching unit 21 of the electronic circuit 30. The switching unit 21 allows a user to switch between the different electronic devices 32 as will be discussed below.

A hood 14 is generally attached to a top section of the backpack 12. The hood 14 is attached so that the user of the device 10 may wear the hood 14 while having the backpack 12 on the shoulder of the user. The hood 14 may be used for warmth or protection from the rain, sun or the like or alternatively as a fashion statement. As shown more clearly in FIG. 4, the hood 14 may be detachably coupled to the backpack 12. In accordance with one embodiment, a sheath 15 may be used to couple the hood 14 to the backpack 12. The sheath 15 would be placed over each shoulder strap 16 to secure the sheath 15 to the backpack 12. A top section of the sheath 15 is removably attached to the hood 14. As shown in the Figures, the sheath 15 aids in covering the neck of the wearer. The sheath 15 further is used to cover and hide the pockets 20 which hold the electronic devices 32 and the switching unit 21. This aids in protecting the electronic devices 32 and the switching unit 21 from theft.

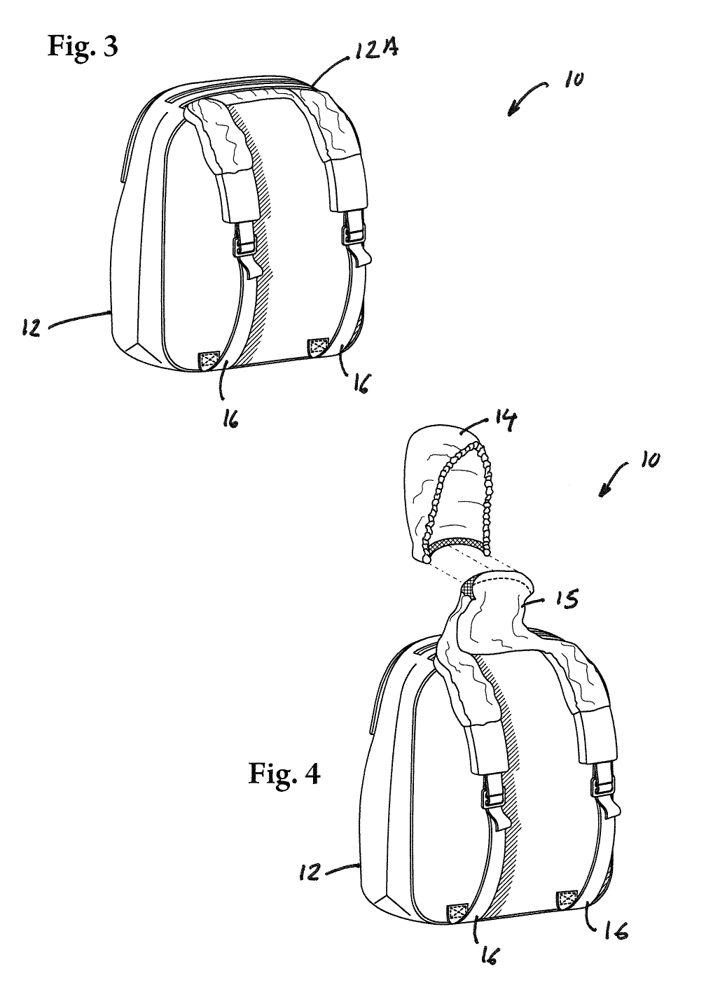

In accordance with one embodiment, as shown more clearly in FIG. 3, the hood 14 may be placed in a compartment 12A of the backpack 12 for storage when not in used. The hood 14 may be placed in the compartment 12A by detaching the hood 14 from the backpack 12 and placing the detached hood 14 in the compartment 12A. Alternatively, the user may keep the hood 14 attached to the backpack 12 and simply stuff the hood in the compartment 12A.

The backpack 12 will have an electronic circuit 30. The electronic circuit 30 allows a user to select between the plurality of electronic devices 32 attached to the electronic circuit 30 for use. The electronic circuit 30 generally comprises a pair of speakers 18. The speakers 18 are attached to a switching unit 21. A microphone 34 may also be attached to the switch 21. The plurality of electronic devices 32 are attached to the switch 21. The electronic devices 32 may be a cell phone, an MP3 player, a tape recorder, and the like. The listing of the above is given as an example and should not be seen as to limit the scope of the present invention. The switch 21 allows a user to select which electronic device 32 will send signals to the speakers 18 and or receive signals from the microphone 34.

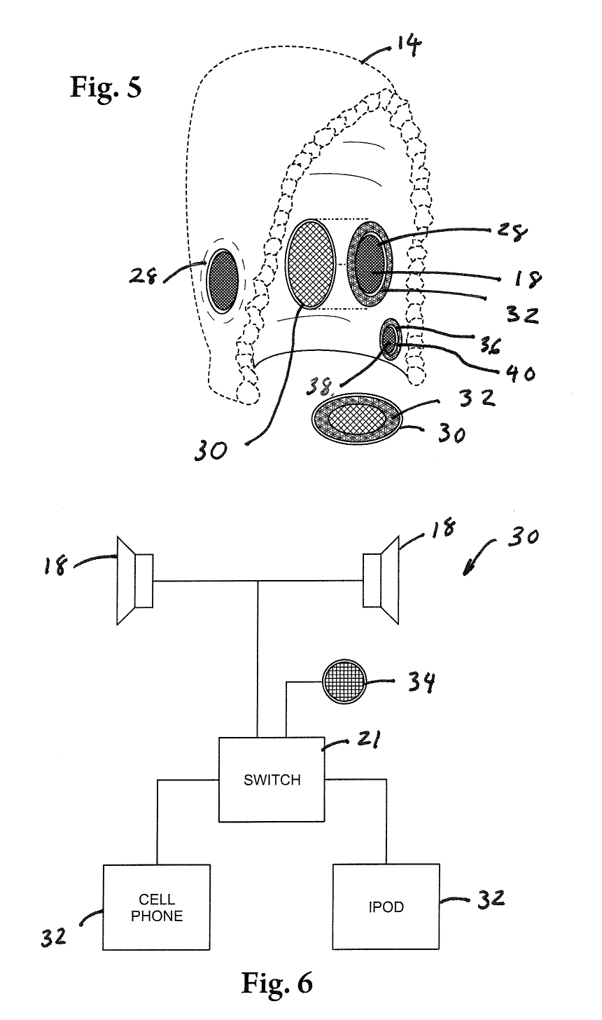

The speakers 18 are located in the hood 14. The speakers 18 are used to allow audible media to be heard from the selected electronic device 32 while wearing the hood 14. As shown more clearly in FIG. 5, a pair of speaker pockets 28 is formed on opposing sides of the hood 14. Each speaker pocket 28 will house one of the pair of speakers 18. A mesh covering 30 is placed over the speaker pocket 28 to secure the speaker 18 in the speaker pocket 28 and to allow the audible media to be heard. The mesh covering 30 is generally detachable from the speaker pocket 28 so that the pair of speakers 18 may be removed. In accordance with one embodiment, the mesh covering 30 is attached to each speaker pocket with a hook and loop material 32. However, other material may be used without departing from the spirit and scope of the present invention.

The microphone 34 may also be located in the hood 14. The microphone 34 is used to transmit audible signals inputted into the microphone 34 to a selected electronic device 32. The microphone 34 is placed in a microphone pocket 36 formed on one side of the hood 14. A mesh covering 38 is placed over the microphone pocket 36 to secure the microphone 34 in the microphone pocket 36 and to allow the audible media to be picked-up by the microphone 34. The mesh covering 38 is generally detachable from the microphone pocket 36 so that the microphone 24 may be removed. In accordance with one embodiment, the mesh covering 38 is attached to the microphone pocket 24 with a hook and loop material 40. However, other material may be used without departing from the spirit and scope of the present invention.

In operation, the user may select which electronic device will send signals to the pair of speakers 18 and receive signals from the microphone 34. As shown in FIG. 6, the user has an MP3 player and a cellular phone plugged into the switching unit 21. If the user has the switching unit 21 positioned on the MP3 Player, the MP3 player will send audible signals to the speakers 18. If a user receives a telephone call on the cellular phone, the switching unit 21 will signal the user that a call is being received by sending a beeping noise to the speakers 18. The user may then position the switching unit 21 to the cellular phone. Thus, audible signals from the cellular phone will now be heard from the speakers 18. Also, audible signals spoken into the microphone 34 will now be sent to the cellular phone. Once the call in completed, the user may switch back to the MP3 Player or place the switching unit 21 in an off position.

While embodiments of the disclosure have been described in terms of various specific embodiments, those skilled in the art will recognize that the embodiments of the disclosure can be practiced with modifications within the spirit and scope of the claims.

What is claimed is:

1. A device for carrying objects comprising;
a backpack;
a pair of shoulder straps coupled to said backpack;
a hood coupled to a top of said backpack, said hood being positioned so that a wearer of said backpack is capable of placing said hood over a head of said wearer; and
at least one speaker coupled to said hood.

2. The device for carrying objects of claim 1 wherein said hood is removable.

3. The device for carrying objects of claim 1 further comprising a hood pocket located on the top of said backpack for stowing said hood.

4. The device for carrying objects of claim 1 wherein said at least one speaker is coupled to an electronic device and capable of receiving an audible signal from the electronic device.

5. The device for carrying objects of claim 4 further comprising at least one speaker pocket for removably and individually housing said at least one speaker.

6. The device for carrying objects of claim 5 wherein said at least one speaker pocket has a removable mesh speaker screen located on an interior of said hood.

7. A device for carrying objects of claim 6 wherein said removable mesh speaker screen is coupled to the interior of said hood by hook and loop fasteners.

8. The device for carrying objects of claim 4 further comprising:
an electronic switch coupled to said at least one speaker to send audible signals to a selected electronic device from a plurality of electronic devices.

9. The device for carrying objects of claim 8 further comprising a plurality of strap pockets located on said shoulder straps for independently and removably housing a plurality of electronic devices and said electronic switch.

10. The device for carrying objects of claim 8 further comprising a microphone coupled to said hood and said electronic switch.

11. The device for carrying objects of claim 10 further comprising a microphone pocket coupled to said hood for removably housing said microphone.

12. The device for carrying objects of claim 11 wherein said microphone pocket has a removable mesh microphone screen located on the interior of said hood.

13. A device for carrying objects of claim 12 wherein said removable mesh microphone screen is coupled to the interior of said hood by hook and loop fasteners.

14. The device for carrying objects of claim 10 wherein said hood is removably coupled to said backpack by an intermediary device, said intermediary device being removably coupled to said backpack and covering said shoulder straps and said plurality of pockets and said switch pocket and said at least one two-way channel.

15. A device for carrying objects comprising;
a backpack;
a pair of shoulder straps coupled to said backpack;
a hood coupled to a top of said backpack, said hood being positioned so that a wearer of said backpack is capable of placing said hood over a head of said wearer;
a plurality of pockets located on said shoulder straps for housing a plurality of electronic devices;
a pair of speakers coupled to said hood;
a switching unit housed in one of the plurality of pockets and coupled to the pair of speakers and to the plurality of electronic devices for sending audible signals to the pair of speakers from a selected electronic device of the plurality of electronic devices;
a pair of speaker pockets formed on opposing sides in an interior section of the hood, wherein each speaker pocket will removably house one of said pair of speakers; and
a pair of speaker mesh screens, wherein each speaker mesh screen is removably attached to an individual speaker pocket.

16. The device for carrying objects of claim 15 wherein said hood is removable.

17. The device for carrying objects of claim 15 further comprising a pocket located on the top of said backpack for stowing said hood.

18. The device for carrying objects of claim 15 further comprising a microphone coupled to said hood and said switching unit.

19. The device for carrying objects of claim 18 further comprising a microphone pocket coupled to said hood for removably housing said microphone.

20. The device for carrying objects of claim 19 wherein said microphone pocket has a removable mesh screen located on the interior of said hood.
